(19) United States
(12) Patent Application Publication
(10) Pub. No.: US 2024/0116757 A1
(43) Pub. Date: Apr. 11, 2024

(54) METHODS FOR CHEMICAL PROCESS HEATING WITH CARBON CAPTURE

(71) Applicant: OHIO STATE INNOVATION FOUNDATION, Columbus, OH (US)

(72) Inventors: Liang-Shih FAN, Columbus, OH (US); Dikai XU, Columbus, OH (US); Dawei WANG, Columbus, OH (US); Qiaochu ZHANG, Columbus, OH (US); Andrew TONG, Columbus, OH (US)

(21) Appl. No.: 18/276,093

(22) PCT Filed: Feb. 8, 2022
(86) PCT No.: PCT/US22/15624

§ 371 Date: Aug. 7, 2023

Related U.S. Application Data
(60) Provisional application No. 63/147,100, filed on Feb. 8, 2021.

(51) Int. Cl. C01B 3/38; B01J 8/06; B01J 8/18; B01J 8/26; C01B 3/26; C01B 32/50; F23C 10/04

(52) U.S. Cl. CPC C01B 3/38; B01J 8/065; B01J 8/067; B01J 8/1827; B01J 8/1836; B01J 8/1881; B01J 8/26; C01B 3/26; C01B 32/50; F23C 10/04; C01B 2203/0233; C01B 2203/0238; C01B 2203/0277; C01B 2203/0838; C01B 2203/1011; C01B 2203/1241; F23C 2206/10; F23C 2900/99008

(57) ABSTRACT

Disclosed herein are systems (e.g., moving bed redox systems) and methods for supplying thermal energy to an endothermic chemical process.

### CROSS-REFERENCE TO RELATED APPLICATIONS

This application claims the benefit of priority to U.S. Provisional Application No. 63/147,100, filed Feb. 8, 2021, which is hereby incorporated herein by reference in its entirety.

### FIELD

The present disclosure relates to systems and methods for supplying thermal energy to endothermic chemical processes, for example with carbon capture using a counter current moving bed redox system.

### BACKGROUND

In the foreseeable future, carbonaceous fuels including fossil fuels will remain the major contributor to global energy supplies. The combustion of carbonaceous fuels has been a major method for generating thermal energy in many industries, such as power generation and chemical production. In particular, the state-of-art technologies for producing a series of chemical products, such as hydrogen, ethylene, and styrene, involve endothermic chemical reactions that occurs in externally heated reactors. The reactors are typically enclosed in a furnace where the combustion of carbonaceous fuels provides the required thermal energy to support the endothermic chemical reactions.

Due to the growing concern over climate change caused by anthropogenic green-house gas emissions, the energy and chemical industries and academia have focused on developing clean energy technologies that reduce or eliminate CO₂ emissions during the conversion of carbonaceous fuels. In order to reduce green-house gas emission from combustion processes, CO₂ capture technologies such as post-combustion capture technologies have been developed to capture the CO₂ produced in the combustion or conversion of carbonaceous fuels. The post-combustion capture technologies typically use a liquid CO₂ sorbent to absorb the CO₂ in the flue gas generated from fuel combustion and regenerates the sorbent by heating in a separate vessel by which a pure CO₂ stream is produced. However, the post-combustion capture technologies are typically inefficient as the regeneration of sorbent consumes a significant amount of thermal energy released from the combustion.

Carbon capture technologies using circulating metal oxide particles have been developed to provide an efficient way to combust carbonaceous fuels while capturing the CO₂ generated. For instance, chemical looping systems use a solid oxygen carrier as the oxidant to convert the carbonaceous fuels into CO₂ in the reducer reactor. The reduced oxygen carrier is regenerated by air in the combustor reactor and releases thermal energy, which can be utilized for power generation. As the carbonaceous fuels do not directly contact air, the generated CO₂ stream is pure, which can be readily sequestrated or utilized with little to no further purification. Chemical looping systems provide higher energy utilization efficiency and lower cost as compared to post-combustion capture technologies.

Rydén et al. proposed to use a chemical looping system for supplying thermal energy to the steam methane reforming (SMR) process (Rydén et al. International Journal of Hydrogen Energy, 2006, 31(10), 1271-1283). The system proposed by Rydén et al. includes a bubbling fluidized bed reducer and a fluidized bed combustor. The tubular steam methane reforming reactor is located in the reducer and is heated by the high temperature fluidized bed materials. Similar systems have been analyzed by Pans et al. to compare configurations with the steam methane reforming reactor in the combustor versus in the reducer (Pans et al. International Journal of Hydrogen Energy, 2013, 38(27), 11878-11892).

The previously proposed methods to integrating the chemical looping system with hydrogen generation involved the use of fluidized bed reducers integrated with the steam methane reforming reaction tubes. The significant gas channeling in fluidized bed reducers may result in incomplete fuel conversion, which necessitates a downstream O₂ polishing unit to fully convert the fuel into CO₂. To maximize fuel conversion, the oxygen carrier in contact with the exiting gas products must be at a high oxidation state, which corresponds to a low oxygen carrier conversion. Thus, the intensive solid mixing in fluidized bed reducers causes a low oxygen conversion or utilization in the oxygen carriers. For an Fe₂O₃-based oxygen carrier, the oxygen carrier can only be reduced to the Fe₃O₄ state, which corresponds to only 11% utilization of the usable oxygen in Fe₂O₃. Further increasing the oxygen carrier conversion, i.e. greater oxygen utilization on the oxygen carrier, will result in a significant loss in fuel conversion due to thermodynamic limits.

Thomas et al. describes a distinct metal oxide-based redox system using a counter-current moving bed reactor for the reduction of the metal oxides (U.S. Pat. No. 7,767,191 B2). By controlling the solid flow pattern and eliminating the axial mixing of the metal oxides in the reducer, the moving bed redox system is able to achieve full fuel conversion to CO₂ while giving a high utilization of oxygen in the metal oxide. When fuels such as coal, CH₄, H₂, and CO are used, up to 50% of the usable oxygen in Fe₂O₃ can be utilized.

### SUMMARY

In accordance with the purposes of the disclosed systems and methods as embodied and broadly described herein, the disclosed subject matter relates to systems and methods for supplying thermal energy to an endothermic chemical process.

For example, disclosed herein are systems for supplying thermal energy to an endothermic chemical process, the systems comprising: a first reactor comprising a moving bed reducer; a second reactor comprising a combustor; a plurality of redox particles comprising a metal oxide based redox material; and an endothermic reactor; wherein the first reactor and the second reactor are interconnected and the system is configured to cycle the plurality of redox particles between the first reactor and the second reactor; wherein the plurality of redox particles have a first oxidation state and a second oxidation state, the second oxidation state being lower than the first oxidation state; wherein the first reactor is configured to receive a carbon-containing reactant and at least a portion of the plurality of redox particles, said portion of the plurality of redox particles being in the first oxidation state; wherein, within the first reactor, the plurality of redox particles flow downwards in a packed moving bed manner while the carbon-containing reactant flows upwards at a velocity below the minimum fluidizing velocity of the plurality of redox particles; wherein the carbon-containing reactant reacts with the plurality of redox particles in the first oxidation state within the first reactor, such that the carbon-containing reactant is oxidized to form an oxidation product and the plurality of redox particles are reduced from the first oxidation state to the second oxidation state; wherein the second reactor is configured to receive air and at least a portion of the plurality of redox particles, said portion of the plurality of redox particles being in the second oxidation state; wherein the plurality of redox particles in the second oxidation state react with the air in the second reactor, such that the plurality of redox particles are oxidized from the second oxidation state to the first oxidation state by the air; wherein the reaction within the first reactor, the reaction within the second reactor, one or more products of the reaction within the first reactor and/or the second reactor, or a combination thereof generates thermal energy; and wherein the endothermic reactor is configured to receive at least a portion of said thermal energy to drive the endothermic chemical process.

Also disclosed herein are methods for supplying thermal energy to an endothermic chemical process, the methods comprising: contacting a carbon-containing reactant with at least a portion of a plurality of redox particles in a first reactor; wherein the first reactor is a moving bed reducer; wherein the plurality of redox particles comprise a metal oxide based redox material, and the plurality of redox particles have a first oxidation state and a second oxidation state; wherein said portion of the plurality of redox particles are in the first oxidation state; wherein, within the first reactor, the plurality of redox particles flow downwards in a packed moving bed manner while the carbon-containing reactant flows upwards at a velocity below the minimum fluidizing velocity of the plurality of redox particles; wherein the carbon-containing reactant reacts with the plurality of redox particles in the first oxidation state within the first reactor, such that the carbon-containing reactant is oxidized to form an oxidation product and the plurality of redox particles are reduced from the first oxidation state to the second oxidation state; transferring at least a portion of the plurality redox particles in the second oxidation state to a second reactor, the second reactor comprising a combustor; contacting said portion of the plurality of redox particles in the second oxidation state with air in the second reactor; wherein the plurality of redox particles in the second oxidation state react with the air in the second reactor, such that the plurality of redox particles are oxidized from the second oxidation state to the first oxidation state by the air; wherein the reaction within the first reactor, the reaction within the second reactor, one or more products of the reaction within the first reactor and/or the second reactor, or a combination thereof generates thermal energy; and transferring at least a portion of said thermal energy to an endothermic reactor to drive the endothermic chemical process. In some examples, the methods can further comprise transferring at least a portion of the plurality of redox particles in the first oxidation state from the second reactor to the first reactor.

In some examples, the second reactor comprises a fluidized bed, a moving bed, or a combination thereof. In some examples, the systems further comprise a third reactor comprising a particle oxidation reactor between and connected to both the first reactor and the second reactor, wherein the particle oxidation reactor is configured to contact the plurality of redox particles with an oxidizing gas to at least partially oxidize the plurality of redox particles. In some examples, the methods further comprise contacting at least a portion of the plurality of redox particles with an oxidizing gas in a third reactor to at least partially oxidize the plurality of redox particles, wherein the third reactor comprises a particle oxidation reactor between and connected to both the first reactor and the second reactor.

Also disclosed herein are systems for supplying thermal energy to an endothermic chemical process, the systems comprising: a first reactor comprising a moving bed reducer; a third reactor comprising a particle oxidation reactor; a plurality of redox particles comprising a metal oxide based redox material; and an endothermic reactor; wherein the first reactor and the third reactor are interconnected and the system is configured to circulate the plurality of redox particles between the first reactor and the third reactor; wherein the plurality of redox particles have a first oxidation state and a second oxidation state, the second oxidation state being lower than the first oxidation state; wherein first reactor is configured to receive a carbon-containing reactant and at least a portion of the plurality of redox particles, said portion of the plurality of redox particles being in the first oxidation state; wherein, within the first reactor, the plurality of redox particles flow downwards in a packed bed moving manner while the carbon-containing reactant flows upwards at a velocity below the minimum fluidizing velocity of the plurality of redox particles; wherein the carbon-containing reactant reacts with the plurality of redox particles in the first oxidation state within the first reactor, such that the carbon-containing reactant is oxidized to form an oxidation product and the plurality of redox particles are reduced from the first oxidation state to the second oxidation state; wherein the third reactor is configured to receive an oxidizing gas and at least a portion of the plurality of redox particles, said portion of the plurality of redox particles being in the second oxidation state; wherein the plurality of redox particles in the second oxidation state react with the oxidizing gas in the third reactor, such that the plurality of redox particles are oxidized from the second oxidation state to the first oxidation state by the oxidation gas; wherein the reaction within the first reactor, the reaction within the third reactor, one or more products of the reaction within the first reactor and/or the third reactor or a combination thereof generates thermal energy; and wherein the endothermic reactor is configured to receive at least a portion of said thermal energy to drive the endothermic chemical process.

Also disclosed herein are methods for supplying thermal energy to an endothermic chemical process, the method comprising: contacting a carbon-containing reactant with at least a portion of a plurality of redox particles in a first reactor; wherein the first reactor is a moving bed reducer; wherein the plurality of redox particles comprise a metal oxide based redox material, and the plurality of redox particles have a first oxidation state and a second oxidation state; wherein said portion of the plurality of redox particles are in the first oxidation state; wherein, within the first reactor, the plurality of redox particles flow downwards in a packed bed moving manner while the carbon-containing reactant flows upwards at a velocity below the minimum fluidizing velocity of the plurality of redox particles; wherein the carbon-containing reactant reacts with the plurality of redox particles in the first oxidation state within the first reactor, such that the carbon-containing reactant is oxidized to form an oxidation product and the plurality of redox particles are reduced from the first oxidation state to the second oxidation state; transferring at least a portion of the plurality of redox particles in the second oxidation state to a third reactor, the third reactor comprising a particle oxidation reactor; contacting said portion of the plurality of redox particles in the second oxidation state with an oxidizing in the third reactor; wherein the plurality of redox particles in the second oxidation state react with the oxidizing gas in the third reactor, such that the plurality of redox particles are oxidized from the second oxidation state to the first oxidation state by the oxidation gas; wherein the reaction within the first reactor, the reaction within the third reactor, one or more products of the reaction within the first reactor and/or the third reactor or a combination thereof generates thermal energy; and transferring at least a portion of said thermal energy to an endothermic reactor to drive the endothermic chemical process. In some examples, the methods can further comprise transferring at least a portion of the plurality of redox particles in the first oxidation state from the third reactor to the first reactor.

In some examples, the particle oxidation reactor is configured as a countercurrent moving bed reactor, a fluidized bed reactor, or a combination thereof.

In some examples, the oxidizing gas is not air. In some examples, the oxidizing gas comprises steam, CO₂, NO₂, SO₂, or a combination thereof.

In some examples, the first reactor comprises a group of moving bed stages, fluidized bed stages, or a combination thereof.

In some examples, the carbon-containing reactant comprises a solid, a liquid, a gas, or a combination thereof. In some examples, the carbon-containing reactant comprises a fluid. In some examples, the carbon-containing reactant comprises natural gas, coal, biomass, or a combination thereof. In some examples, the carbon-containing reactant is produced in another process that is upstream or downstream of the endothermic reactor. In some examples, the carbon-containing reactant is a slip stream of the products or a tail gas from the upstream or downstream process.

In some examples, the oxidation products comprise CO₂, H₂O, or a combination thereof. In some examples, the oxidation products comprise CO₂ and H₂O. In some examples, the oxidation products comprise CO₂ and H₂O and the systems further comprise a condenser configured to receive the oxidation products and condense the water, thereby purifying the CO₂. In some examples, the oxidation products comprise CO₂ and H₂O and the methods further comprise sending the oxidation products to a condenser and condensing the water in the condenser, thereby purifying the CO₂.

In some examples, the plurality of redox particles comprise an iron oxide. In some examples, the plurality of redox particles in the first oxidation state comprises Fe₂O₃. In some examples, the plurality of redox particles in the second oxidation state comprise FeO. In some examples, the plurality of redox particles are substantially spherical in shape. In some examples, the plurality of redox particles have an average particle size of from 0.4 millimeters (mm) to 10 mm.

In some examples, the endothermic reactor is a tube-type reactor. In some examples, the endothermic reactor is embedded inside the first reactor; the second reactor (when present); the third reactor (when present); a conduit fluidly connected to and downstream of the first reactor, the second reactor, the third reactor, or a combination thereof; or a combination thereof. In some examples, the endothermic reactor is located horizontally and/or vertically inside the second reactor. In some examples, the endothermic reactor forms an outer wall of the first reactor and/or the second reactor.

In some examples, the systems further comprise a riser configured to transfer the plurality of redox particles from the first reactor to the second reactor or the third reactor, or vice versa. In some examples, the plurality of redox particles are transferred between the first reactor and the second reactor or the third reactor, or vice versa, via a riser. In some examples, the endothermic reactor forms an outer wall of the riser and/or is embedded within the riser.

In some examples, the endothermic reactor operated at a temperature of from 300 to 1500° C. In some examples, the endothermic reactor operated at a pressure of from 0 to 300 atm.

In some examples, the flow in the endothermic reactor is in the form of gas, slurry, gas-solid, gas-liquid, or gas-liquid-solid. In some examples, the endothermic reactor comprises a fixed bed packed by a catalyst.

In some examples, the endothermic chemical process comprises steam methane reforming, methane dry reforming, methane dehydrogenation, ethane dehydrogenation, propane dehydrogenation, ethylbenzene dehydrogenation, or a combination thereof. In some examples, the endothermic chemical process comprises steam methane reforming. In some examples, the carbon-containing reactant comprises natural gas and the endothermic chemical process comprises steam methane reforming for H₂ production from natural gas. In some examples, the endothermic chemical process comprises steam methane reforming and the endothermic reactor is a steam reformer embedded in the second reactor, such that thermal energy from the plurality of redox particles in the second reactor is transferred to the steam reformer to support the endothermic steam methane reforming reaction. In some examples, a product gas from the steam reformer is further converted, conditioned, and separated in a downstream process to produce concentrated H₂. In some examples, a tail gas from the downstream H₂ purification process comprises H₂, CO, and unreacted methane, and wherein said tail gas is sent to the first reactor as the carbon-containing reactant. In some examples, a portion of the natural gas along with the tail gas from H₂ production are injected into the first reactor and converted to concentrated CO₂. In some examples, the tail gas from the downstream H₂ production and the carbon-containing reactant are injected into the first reactor at different locations.

In some examples, the systems further comprise a solar receiver between the first reactor and the second reactor or the third reactor, wherein the solar receiver is configured to transfer solar thermal energy to the plurality of redox particles.

In some examples, the systems further comprise a plurality of solid particles configured to increase the heat capacity of the system, remove contaminants from the carbon-containing reactant, or a combination thereof.

Also disclosed herein are methods of use of any of the systems disclosed herein.

Additional advantages of the disclosed methods, systems, and devices will be set forth in part in the description which follows, and in part will be obvious from the description. The advantages of the disclosed methods, systems, and devices will be realized and attained by means of the elements and combinations particularly pointed out in the appended claims. It is to be understood that both the foregoing general description and the following detailed description are exemplary and explanatory only and are not restrictive of the disclosed systems and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

The accompanying figures, which are incorporated in and constitute a part of this specification, illustrate several aspects of the disclosure, and together with the description, serve to explain the principles of the disclosure.

FIG. 1 shows the concept of an example process as disclosed herein according to one implementation.

FIG. 2 shows an example process as disclosed herein according to one implementation where product and/or tail gas is fed to the moving bed reducer.

FIG. 3 shows an example that integrates the moving bed redox system with the steam methane reforming process.

FIG. 4 shows an example with an endothermic reactor installed horizontally in the combustor. FIG. 4 also shows a riser connecting the combustor to the moving bed reducer, the riser being configured to transfer the plurality of redox particles from the combustor to the moving bed reducer.

FIG. 5 shows an example with an endothermic reactor installed vertically in the combustor.

FIG. 6 shows an example with an endothermic reactor installed as the wall of the redox reactor system.

FIG. 7 shows an example with an endothermic reactor installed inside and as the wall of the redox reactor system.

FIG. 8 shows an example with an endothermic reactor installed as the wall of the riser (e.g., a pneumatic riser).

FIG. 9 shows an example with an endothermic reactor installed inside the riser (e.g., a pneumatic riser).

FIG. 10 shows the form of reactant flow in the endothermic reactor in one example.

FIG. 11 shows an example where the endothermic reactor is a packed bed reactor.

### DETAILED DESCRIPTION

The methods, systems, and devices described herein may be understood more readily by reference to the following detailed description of specific aspects of the disclosed subject matter and the Examples included therein.

Before the present methods, systems, and devices are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

In this specification and in the claims that follow, reference will be made to a number of terms, which shall be defined to have the following meanings.

Throughout the description and claims of this specification, the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

“Exemplary” means “an example of” and is not intended to convey an indication of a preferred or ideal embodiment. “Such as” is not used in a restrictive sense, but for explanatory purposes.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

Systems and Methods

Disclosed herein are systems (e.g., moving bed redox systems) and methods for supplying thermal energy to an endothermic chemical process. In some examples, the systems (e.g., moving bed redox systems) for supplying thermal energy to an endothermic chemical process comprise: a first reactor (e.g., one or more first reactors) comprising a moving bed reducer; a second reactor (e.g., one or more second reactors) comprising a combustor; a plurality of redox particles; and an endothermic reactor (e.g., one or more endothermic reactors).

The first reactor and the second reactor are interconnected and the system is configured to cycle the plurality of redox particles between the first reactor and the second reactor (e.g., from the first reactor to the second reactor and vice versa), wherein the plurality of redox particles cycling from the first reactor to the second reactor and back to the first reactor is considered a “loop.”

The plurality of redox particles comprise a metal oxide based redox material. In some examples, the plurality of redox particles comprise an iron oxide.

The plurality of redox particles have a first oxidation state and a second oxidation state, the second oxidation state being lower than the first oxidation state. In some examples, the plurality of redox particles in the first oxidation state comprises Fe₂O₃. In some examples, the plurality of redox particles in the second oxidation state comprise FeO.

The plurality of redox particles can comprise particles of any shape (e.g., a sphere, a rod, a quadrilateral, an ellipse, a triangle, a polygon, etc.). In some examples, the plurality of redox particles can have a regular shape, an irregular shape, an isotropic shape, an anisotropic shape, or a combination thereof. In some examples, the plurality of redox particles are each substantially spherical in shape.

The plurality of redox particles can have an average particle size. “Average particle size” and “mean particle size” are used interchangeably herein, and generally refer to the statistical mean particle size of the particles in a population of particles. For example, the average particle size for a plurality of particles with a substantially spherical shape can comprise the average diameter of the plurality of particles. For a particle with a substantially spherical shape, the diameter of a particle can refer, for example, to the hydrodynamic diameter. As used herein, the hydrodynamic diameter of a particle can refer to the largest linear distance between two points on the surface of the particle. For an anisotropic particle, the average particle size can refer to, for example, the average maximum dimension of the particle (e.g., the length of a rod shaped particle, the diagonal of a cube shape particle, the bisector of a triangular shaped particle, etc.). For an anisotropic particle, the average particle size can refer to, for example, the hydrodynamic size of the particle. Mean particle size can be measured using methods known in the art.

In some examples, the plurality of redox particles can have an average particle size of 0.4 millimeters (mm) or more (e.g., 0.5 mm or more, 0.6 mm or more, 0.7 mm or more, 0.8 mm or more, 0.9 mm or more, 1 mm or more, 1.25 mm or more, 1.5 mm or more, 1.75 mm or more, 2 mm or more, 2.25 mm or more, 2.5 mm or more, 2.75 mm or more, 3 mm or more, 3.25 mm or more, 3.5 mm or more, 3.75 mm or more, 4 mm or more, 4.25 mm or more, 4.5 mm or more, 4.75 mm or more, 5 mm or more, 5.5 mm or more, 6 mm or more, 6.5 mm or more, 7 mm or more, 7.5 mm or more, 8 mm or more, 8.5 mm or more, 9 mm or more, or 9.5 mm or more). In some examples, the plurality of redox particles can have an average particle size of 10 mm or less (e.g., 9.5 mm or less, 9 mm or less, 8.5 mm or less, 8 mm or less, 7.5 mm or less, 7 mm or less, 6.5 mm or less, 6 mm or less, 5.5 mm or less, 5 mm or less, 4.75 mm or less, 4.5 mm or less, 4.25 mm or less, 4 mm or less, 3.75 mm or less, 3.5 mm or less, 3.25 mm or less, 3 mm or less, 2.75 mm or less, 2.5 mm or less, 2.25 mm or less, 2 mm or less, 1.75 mm or less, 1.5 mm or less, 1.25 mm or less, 1 mm or less, 0.9 mm or less, 0.8 mm or less, 0.7 mm or less, 0.6 mm or less, or 0.5 mm or less). The average particle size of the plurality of redox particles can range from any of the minimum, values described above to any of the maximum values described above. For example, the plurality of redox particles can have an average particle size of from 0.4 mm to 10 mm (e.g., from 0.4 mm to 5 mm, from 5 mm to 10 mm, from 0.4 mm to 2 mm, from 2 mm to 4 mm, from 4 mm to 6 mm, from 6 mm to 8 mm, from 8 mm to 10 mm, from 0.4 mm to 9 mm, from 0.5 mm to 10 mm, from 0.5 mm to 9 mm, from 1 mm to 10 mm, or from 2 mm to 10 mm).

In some examples, the plurality of redox particles can be substantially monodisperse. “Monodisperse” and “homogeneous size distribution,” as used herein, and generally describe a population of particles where all of the particles are the same or nearly the same size. As used herein, a monodisperse distribution refers to particle distributions in which 80% of the distribution (e.g., 85% of the distribution, 90% of the distribution, or 95% of the distribution) lies within 25% of the average particle size (e.g., within 20% of the average particle size, within 15% of the average particle size, within 10/o of the average particle size, or within 5% of the average particle size).

The first reactor is configured to receive a carbon-containing reactant and at least a portion of the plurality of redox particles (e.g., from the second reactor), said portion of the plurality of redox particles being in the first oxidation state. Within the first reactor, the plurality of redox particles flow downwards in a packed moving bed manner while the carbon-containing reactant flows upwards at a velocity below the minimum fluidizing velocity of the plurality of redox particles. The carbon-containing reactant reacts with the plurality of redox particles in the first oxidation state within the first reactor, such that the carbon-containing reactant is oxidized to form an oxidation product and the plurality of redox particles are reduced from the first oxidation state to the second oxidation state.

In some examples, the first reactor comprises a group of moving bed stages, fluidized bed stages, or a combination thereof.

The carbon-containing reactant can, for example, comprise a solid, a liquid, a gas, or a combination thereof. In some examples, the carbon-containing reactant comprises a fluid. As used herein, a “fluid” includes a liquid, a gas, a supercritical fluid, or a combination thereof. The carbon-containing reactant can, for example, comprise natural gas, coal, biomass, or a combination thereof. The term “biomass,” as used herein, refers to living or dead biological material that can be used in one or more of the disclosed systems or methods.

In some examples, the carbon-containing reactant is produced in another process that is upstream or downstream of the endothermic reactor. In some examples, the carbon-containing reactant is a slip stream of the products or a tail gas from the upstream or downstream process.

In some examples, the oxidation products (e.g., of the carbon-containing reactant) comprise CO₂, H₂O, or a combination thereof.

In some examples, the oxidation products comprise CO₂ and H₂O. In some examples, the system further comprises a condenser configured to receive the oxidation products and condense the water, thereby purifying the CO₂.

The second reactor is configured to receive air and at least a portion of the plurality of redox particles (e.g., from the first reactor), said portion of the plurality of redox particles being in the second oxidation state. The plurality of redox particles in the second oxidation state react with the air in the second reactor, such that the plurality of redox particles are oxidized from the second oxidation state to the first oxidation state by the air. The second reactor can, for example, comprise a fluidized bed, a moving bed, or a combination thereof.

In some examples, the systems can further comprise a third reactor comprising a particle oxidation reactor between and connected to both the first reactor and the second reactor, wherein the particle oxidation reactor is configured to contact the plurality of redox particles with an oxidizing gas to at least partially oxidize the plurality of redox particles, e.g. from the second oxidation state to the first oxidation state.

Also disclosed herein are systems for supplying thermal energy to an endothermic chemical process, the systems comprising: a first reactor (e.g., one or more first reactors) comprising a moving bed reducer, a third reactor (e.g., one or more third reactors) comprising a particle oxidation reactor; a plurality of redox particles comprising a metal oxide based redox material; and an endothermic reactor (e.g., one or more endothermic reactors). The first reactor and the third reactor are interconnected and the system is configured to circulate the plurality of redox particles between the first reactor and the third reactor (e.g., from the first reactor to the third reactor and vice versa), wherein the plurality of redox particles cycling from the first reactor to the second reactor and back to the first reactor is considered a “loop.” The plurality of redox particles have a first oxidation state and a second oxidation state, the second oxidation state being lower than the first oxidation state. The first reactor is configured to receive a carbon-containing reactant and at least a portion of the plurality of redox particles (e.g., from the third reactor), said portion of the plurality of redox particles being in the first oxidation state. Within the first reactor, the plurality of redox particles flow downwards in a packed bed moving manner while the carbon-containing reactant flows upwards at a velocity below the minimum fluidizing velocity of the plurality of redox particles. The carbon-containing reactant reacts with the plurality of redox particles in the first oxidation state within the first reactor, such that the carbon-containing reactant is oxidized to form an oxidation product and the plurality of redox particles are reduced from the first oxidation state to the second oxidation state. The third reactor is configured to receive an oxidizing gas and at least a portion of the plurality of redox particles, said portion of the plurality of redox particles being in the second oxidation state. The plurality of redox particles in the second oxidation state react with the oxidizing gas in the third reactor, such that the plurality of redox particles are oxidized from the second oxidation state to the first oxidation state by the oxidation gas.

The particle oxidation reactor can, for example, be configured as a countercurrent moving bed reactor, a fluidized bed reactor, or a combination thereof.

In some examples, the oxidizing gas is not air. The oxidizing gas can, for example, comprise steam, CO₂, NO₂, SO₂, or a combination thereof.

In the systems disclosed herein, the reaction within the first reactor; the reaction within the second reactor (when present); the reaction within the third reactor (when present); one or more products of the reaction within the first reactor; one or more products of the reaction within the second reactor (when present); one or more products of the reaction within the third reactor (when present); or a combination thereof generates thermal energy, and the endothermic reactor (e.g., one or more endothermic reactors) is configured to receive at least a portion of said thermal energy to drive the endothermic chemical process.

The endothermic reactor can, for example, comprise a tube-type reactor.

In some examples, the endothermic reactor is embedded inside the first reactor; the second reactor (when present); the third reactor (when present); a conduit fluidly connected to and downstream of the first reactor, the second reactor, the third reactor, or a combination thereof (e.g., through which a product passes); or a combination thereof.

In some examples, the endothermic reactor is located horizontally and/or vertically inside the second reactor. In some examples, the endothermic reactor forms an outer wall of the first reactor and/or the second reactor.

In some examples, the system can further comprise a riser (e.g., one or more risers) configured to transfer the plurality of redox particles from the first reactor to the second reactor or the third reactor, or vice versa. In some examples, the endothermic reactor forms an outer wall of the riser and/or is embedded within the riser. The riser can comprise any suitable riser, such as those known in the art, for example, a pneumatic riser.

In some examples, the endothermic reactor can be operated at a temperature of 300° C. or more (e.g., 325° C. or more, 350° C. or more, 375° C. or more, 400° C. or more, 425° C. or more, 450° C. or more, 475° C. or more, 500° C. or more, 525° C. or more, 550° C. or more, 575° C. or more, 600° C. or more, 650° C. or more, 700° C. or more, 750° C. or more, 800° C. or more, 850° C. or more, 900° C. or more, 950° C. or more, 1000° C. or more, 1100° C. or more, 1200° C. or more, 1300° C. or more, or 1400° C. or more). In some examples, the endothermic reactor can be operated at a temperature of 1500° C. or less (e.g., 1400° C. or less, 1300° C. or less, 1200° C. or less, 1100° C. or less, 1000° C. or less, 950° C. or less, 900° C. or less, 850° C. or less, 800° C. or less, 750° C. or less, 700° C. or less, 650° C. or less, 600° C. or less, 575° C. or less, 550° C. or less, 525° C. or less, 500° C. or less, 475° C. or less, 450° C. or less, 425° C. or less, 400° C. or less, 375° C. or less, 350° C. or less, or 325° C. or less). The temperature at which the endothermic reactor is operated can range from any of the minimum values described above to any of the maximum values described above. For example, the endothermic reactor can be operated at a temperature of from 300° C. to 1500° C. (e.g., from 300° C. to 900° C., from 900° C. to 1500° C., from 300° C. to 600° C., from 600° C. to 900° C., from 900° C. to 1200° C., from 1200° C. to 1500° C., from 350° C. to 1500° C., from 300° C. to 1400° C., from 350° C. to 1400° C., from 500° C. to 1500° C., or from 1000° C. to 1500° C.).

In some examples, the endothermic reactor can be operated at a pressure of 0 atmospheres (atm) or more (e.g., 1 atm or more, 2 atm or more, 3 atm or more, 4 atm or more, 5 atm or more, 6 atm or more, 7 atm or more, 8 atm or more, 9 atm or more, 10 atm or more, 15 atm or more, 20 atm or more, 25 atm or more, 30 atm or more, 35 atm or more, 40 atm or more, 45 atm or more, 50 atm or more, 60 atm or more, 70 atm or more, 80 atm or more, 90 atm or more, 100 atm or more, 125 atm or more, 150 atm or more, 175 atm or more, 200 atm or more, 225 atm or more, 250 atm or more, or 275 atm or more). In some examples, the endothermic reactor can be operated at a pressure of 300 atm or less (e.g., 275 atm or less, 250 atm or less, 225 atm or less, 200 atm or less, 175 atm or less, 150 atm or less, 125 atm or less, 100 atm or less, 90 atm or less, 80 atm or less, 70 atm or less, 60 atm or less, 50 atm or less, 45 atm or less, 40 atm or less, 35 atm or less, 30 atm or less, 25 atm or less, 20 atm or less, 15 atm or less, 10 atm or less, 9 atm or less, 8 atm or less, 7 atm or less, 6 atm or less, 5 atm or less, 4 atm or less, 3 atm or less, 2 atm or less, or 1 atm or less). The pressure at which the endothermic reactor is operated can range from any of the minimum values described above to any of the maximum values described above. For example, the endothermic reactor can be operated at a pressure of from 0 atm to 300 atm (e.g., from 0 atm to 150 atm, from 150 atm to 300 atm, from 0 atm to 100 atm, from 100 atm to 200 atm, from 200 atm to 300 atm, from 0 atm to 10 atm, from 10 atm to 100 atm, from 100 atm to 300 atm, from 1 atm to 300 atm, from 0 atm to 290 atm, or from 1 atm to 290 atm).

In some examples, the flow in the endothermic reactor is in the form of gas, slurry, gas-solid, gas-liquid, or gas-liquid-solid. In some examples, the endothermic reactor comprises a fixed bed packed by a catalyst.

The endothermic chemical process can comprise any suitable process consistent with the methods and systems disclosed herein. For example, the endothermic chemical process can comprise steam methane reforming, methane dry reforming, methane dehydrogenation, ethane dehydrogenation, propane dehydrogenation, ethylbenzene dehydrogenation, or a combination thereof.

In some examples, the endothermic chemical process comprises steam methane reforming. In some examples, the carbon-containing reactant comprises natural gas and the endothermic chemical process comprises steam methane reforming for H₂ production from natural gas.

In some examples, the endothermic chemical process comprises steam methane reforming and the endothermic reactor is a steam reformer embedded in the second reactor (e.g., combustor), such that thermal energy from the plurality of redox particles in the second reactor is transferred to the steam reformer to support the endothermic steam methane reforming reaction. In some examples, a product gas from the steam reformer is further converted, conditioned, and separated in a downstream process to produce concentrated H₂. In some examples, a tail gas from the downstream H₂ purification process comprises H₂, CO, and unreacted methane, and wherein said tail gas is sent to the first reactor as the carbon-containing reactant. In some examples, a portion of the natural gas along with the tail gas from H₂ production are injected into the first reactor and converted to concentrated CO₂. In some examples, the tail gas from the downstream H₂ production and the carbon-containing reactant are injected into the first reactor at different (vertical) locations (e.g., staged injection).s The systems can, in some examples, further comprise a solar receiver between the first reactor and the second reactor or the third reactor, wherein the solar receiver is configured to transfer solar thermal energy to the plurality of redox particles (e.g., as they are transferred from the first reactor to the second reactor or vice versa).

In some examples, the systems can further comprise a plurality of solid particles configured to increase the heat capacity of the system, remove contaminants from the carbon-containing reactant, or a combination thereof.

Also disclosed herein are methods of use of any of the systems disclosed herein. For example, also disclosed herein are method for supplying thermal energy to an endothermic chemical process, e.g. using any of the systems disclosed herein.

Also disclosed herein are methods for supplying thermal energy to an endothermic chemical process, the methods comprising:
contacting a carbon-containing reactant with at least a portion of a plurality of redox particles in a first reactor;
wherein the first reactor is a moving bed reducer;
wherein the plurality of redox particles comprise a metal oxide based redox material, and the plurality of redox particles have a first oxidation state and a second oxidation state;
wherein said portion of the plurality of redox particles are in the first oxidation state;
wherein, within the first reactor, the plurality of redox particles flow downwards in a packed moving bed manner while the carbon-containing reactant flows upwards at a velocity below the minimum fluidizing velocity of the plurality of redox particles;
wherein the carbon-containing reactant reacts with the plurality of redox particles in the first oxidation state within the first reactor, such that the carbon-containing reactant is oxidized to form an oxidation product and the plurality of redox particles are reduced from the first oxidation state to the second oxidation state;
transferring at least a portion of the plurality redox particles in the second oxidation state to a second reactor, the second reactor comprising a combustor;
contacting said portion of the plurality of redox particles in the second oxidation state with air in the second reactor
wherein the plurality of redox particles in the second oxidation state react with the air in the second reactor, such that the plurality of redox particles are oxidized from the second oxidation state to the first oxidation state by the air;
wherein the reaction within the first reactor, the reaction within the second reactor, one or more products of the reaction within the first reactor and/or the second reactor, or a combination thereof generates thermal energy; and
transferring at least a portion of said thermal energy to an endothermic reactor (e.g., one or more) to drive the endothermic chemical process.

In some examples, the methods can further comprise transferring at least a portion of the plurality of redox particles in the first oxidation state from the second reactor to the first reactor.

In some examples, the methods can further comprise contacting at least a portion of the plurality of redox particles with an oxidizing gas in a third reactor to at least partially oxidize the plurality of redox particles, e.g. from the second oxidation state to the first oxidation state, wherein the third reactor comprises a particle oxidation reactor between and connected to both the first reactor and the second reactor.

Also disclosed herein are methods for supplying thermal energy to an endothermic chemical process, the methods comprising:
contacting a carbon-containing reactant with at least a portion of a plurality of redox particles in a first reactor;
wherein the first reactor is a moving bed reducer;
wherein the plurality of redox particles comprise a metal oxide based redox material, and the plurality of redox particles have a first oxidation state and a second oxidation state;
wherein said portion of the plurality of redox particles are in the first oxidation state;
wherein, within the first reactor, the plurality of redox particles flow downwards in a packed bed moving manner while the carbon-containing reactant flows upwards at a velocity below the minimum fluidizing velocity of the plurality of redox particles;
wherein the carbon-containing reactant reacts with the plurality of redox particles in the first oxidation state within the first reactor, such that the carbon-containing reactant is oxidized to form an oxidation product and the plurality of redox particles are reduced from the first oxidation state to the second oxidation state;
transferring at least a portion of the plurality of redox particles in the second oxidation state to a third reactor, the third reactor comprising a particle oxidation reactor;
contacting said portion of the plurality of redox particles in the second oxidation state with an oxidizing in the third reactor;
wherein the plurality of redox particles in the second oxidation state react with the oxidizing gas in the third reactor, such that the plurality of redox particles are oxidized from the second oxidation state to the first oxidation state by the oxidation gas;
wherein the reaction within the first reactor, the reaction within the third reactor, one or more products of the reaction within the first reactor and/or the third reactor or a combination thereof generates thermal energy; and
transferring at least a portion of said thermal energy to an endothermic reactor to drive the endothermic chemical process

In some examples, the methods can further comprise transferring at least a portion of the plurality of redox particles in the first oxidation state from the third reactor to the first reactor.

In some examples, the oxidation products comprise CO₂ and H₂O and the methods can further comprise sending the oxidation products to a condenser and condensing the water in the condenser, thereby purifying the CO₂.

### Example Systems and Methods

For example, the systems and methods disclosed herein provide a method for supplying thermal energy to endothermic chemical processes with carbon capture using moving bed based redox systems.

In some examples, the systems (e.g., the moving bed based redox systems) comprise at least two groups of interconnected reactors, namely, a moving bed reducer and a combustor (e.g., fluidized bed combustor). Each group of reactors can comprise one or more reactors. A plurality of redox particles comprising a metal oxide based redox material are circulated between the reactors. In the moving bed reducer, the plurality of redox particles flow downwards in a packed moving bed manner, while the gas flows upwards where the velocity is maintained below the minimum fluidizing velocity of the plurality of redox particles. Carbon-containing reactants are introduced to the moving bed reducer to react with the plurality of redox particles to form CO₂, H₂O, and/or other oxidation products, while the plurality of redox particles are reduced to a lower oxidation state. The carbon-containing reactant can be in the form of gas, liquid, solid or a combination thereof. In the combustor, the reduced plurality of redox particles from the moving bed reducer enter the combustor where air is used to re-oxidize the plurality of redox particles. The combustor can be operated as a fluidized bed, a moving bed, or a combination thereof. The re-oxidized plurality of redox particles are then transported to the solids inlet of the moving bed reducer to complete a loop (e.g. using a means for transporting the particles, such as a riser, such as a pneumatic riser). The overall reaction in the redox system is the oxidation reaction of the carbon-containing reactants with oxygen from air, which releases a large amount of heat. The heat generated can be utilized to drive endothermic reactions to produce other products with proper integration.

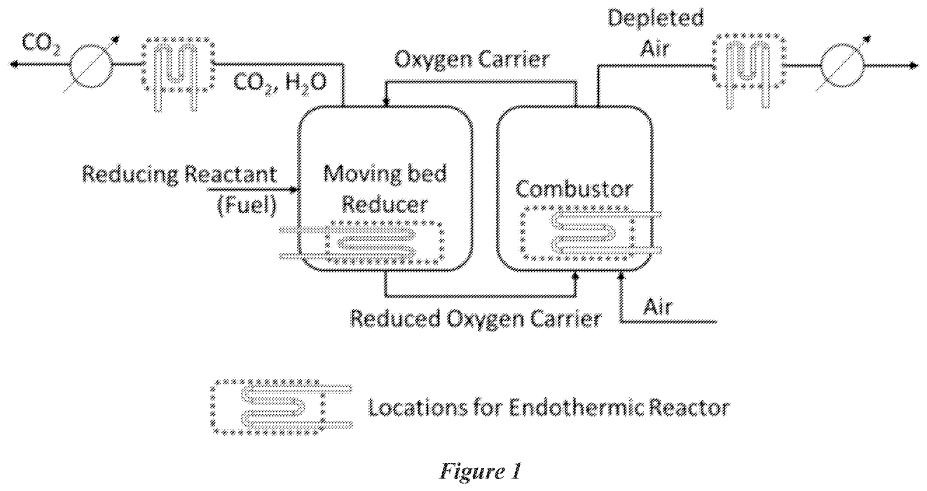

In said process, as shown in FIG. 1, the endothermic reaction occurs in an endothermic reactor. The endothermic reactor can, for example, be embedded inside the moving bed reducer, the combustor, the gas outlet passes downstream of the reactors, or a combination thereof. Embedding the endothermic reactor in the combustor (e.g., fluidized bed combustor) can provide high heat transfer coefficient while potentially causing more erosion on the reactor material. Embedding the endothermic reactor in the moving bed reactor can result in a lower erosion and lower heat transfer coefficient. The endothermic reactor can be operated under high temperature and/or pressure conditions. For example, the endothermic reactor can be operated at a temperature ranging from 300 to 1500° C. and/or a pressure ranging from 0 to 300 atm. Thermal energy in the plurality of redox particles and/or the gases in the moving bed redox system is transferred to the endothermic reactor for supporting the endothermic reaction therein.

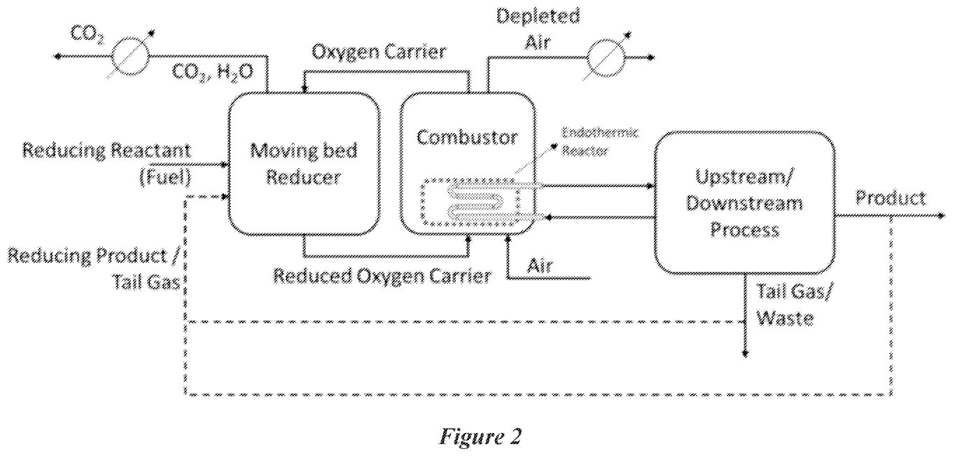

In certain examples, the carbon-containing reactant, or fuel, being fed into the moving bed reducer is natural gas, coal, biomass, or the combination thereof. The carbon-containing reactants are oxidized to form CO₂ and H₂O. The CO₂ generated from the moving bed reducer is not diluted by N₂ present in air and can be readily sequestrated or utilized after condensing the water byproduct. In certain examples, as shown in FIG. 2, the carbon containing reactants produced from another process that is upstream or downstream of the endothermic reactor are fed to the moving bed redox system as the fuel alone or along with other fuels. In certain examples, the carbon containing reactants are a slip stream of the products or the tail gas that is upstream or downstream of process. The carbonaceous species in the carbon containing reactants are converted to pure CO₂ for utilization or sequestration.

In certain examples, the endothermic reactor (e.g., embedded into the moving bed reducer and/or the combustor) is used to perform one of the following chemical reactions:
steam methane reforming: CH₄+H₂O=CO+3H₂
methane dry reforming: CH₄+CO₂=2CO+2H₂
methane dehydrogenation: CH₄═C₂H₄ (and/or +C₆H₆)+H₂,
ethane dehydrogenation: C₂H₆=C₂H₄+H₂
propane dehydrogenation: C₃H₈=C₃H₆+H₂
ethylbenzene dehydrogenation: C₆H_{S}C₂H_{S}=C₆H_{S}C₂H₃+H₂

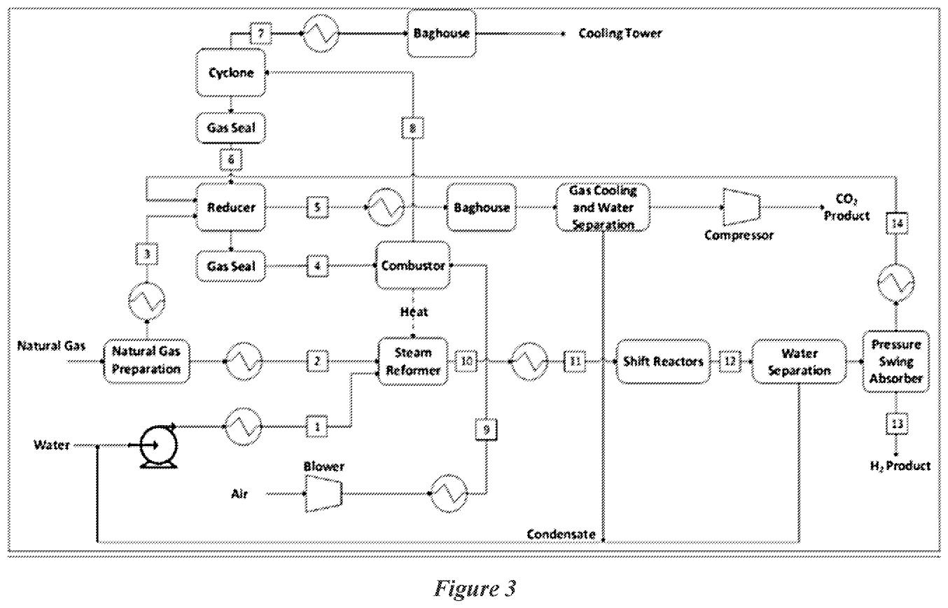

In one example, as shown in FIG. 3, the endothermic reactor is used to perform the steam methane reforming (SMR) reaction for H₂ production from natural gas. The steam methane reforming reactor, named steam reformer, is embedded in the combustor of the moving bed redox system. Thermal energy from the plurality of redox particles in the combustor is transferred to the steam reformer for supporting the endothermic steam methane reforming reaction. The product gas from the steam reformer is further converted, conditioned, and separated in downstream process to produce concentrated H₂. The tail gas from the downstream H₂ purification process, which contains H₂, CO, and unreacted methane, is sent to the moving bed reducer as a carbon containing reactant. A portion of the natural gas, along with the tail gas from H₂ production, is injected to the bottom of the moving bed reducer and is converted to concentrated CO₂.

Table 1 below compares the process simulation results for key performance parameters for the conventional steam methane reforming process with carbon capture and that for the process using moving bed redox system.

TABLE 1
Process simulation results for key performance parameters for
conventional steam methane reforming process with carbon capture
and that for the process using moving bed redox system.

| | Conventional | |
|---|---|---|
| | steam methane | Moving bed |
| | reforming w/ | redox |
| | carbon capture | system |
| Natural gas input (kmol/hr) | 100 | 100 |
| Electricity consumption (MW) | 0.62 | 0.85 |
| H₂ production (kmol/hr) | 232 | 249 |
| Cold gas efficiency | 72% | 77% |
| Effective thermal efficiency | 70% | 74% |

As shown in Table 1, compared to the conventional steam methane reforming process with carbon capture, the moving bed redox system can increase the H₂ production, cold gas efficiency, and effective thermal efficiency by 7 percentage points under the same natural gas input. In addition, the moving bed redox process eliminates the need for the costly post-combustion carbon capture system on the flue gas from the steam methane reforming furnace and the acid gas removal unit downstream of the water gas shift reactor, resulting in substantial capital cost savings when employing carbon capture methods for H₂ production. Thus, the process is economically advantageous over the conventional process.

In another example, the tail gas from H₂ production can be injected into the moving bed reducer at a higher location, while the natural gas can be introduced at the lowest point in the moving bed reducer. When reducing reactants with higher oxidized contents, such as CO₂ and H₂O, are injected to a higher location while those with higher purity of reducing molecules, such as CH₄ and H₂, are injected to the bottom of the counter-current reducer, the plurality of redox particles can be reduced to a lower oxidation state that is thermodynamically infeasible without the stage injection. Thus, a higher amount of oxygen from the plurality of redox particles can be utilized, which in turn reduces the circulation rate of the plurality of redox particles in the moving bed redox system. Although the fluidized bed redox system produces similar efficiency improvement over the conventional process, the oxygen utilization from the oxygen carrier is thermodynamically limited. Thus, the circulation rate of the plurality of redox particles is more than 300% higher for the fluidized bed reducer design than that of the moving bed redox system when processing the same natural gas input to a product gas stream comprising predominantly (i.e. >90%) CO₂ and H₂O. The high particle circulation requirement in the fluidized bed design is due to the limited oxygen utilization, which is required in the fluidized bed reducer to maximize the amount of CO₂ produced from the carbon containing reactant. Staging the carbon containing reactant injection in the moving bed reducer can further reduce the solid circulation rate by 2%-20% compared to a single height injection. Because the reactor volume of the redox system and attrition rate of the plurality of redox particles are proportional to the circulation rate of the plurality of redox particles, the moving bed redox system has a substantially smaller reactor size, lowering the capital cost, and substantially reduces the operating costs due to the lower particle make-up rate required when processing the same amount of carbon containing reactant. The attrition rate is a function of the solid circulation rate, which is directly proportional to the particle make-up rate, which is commonly a significant economic factor to consider in the operating expense in redox particle processes. Equivalently, under the same particle circulation rate, the moving bed redox system can process a higher amount of carbon containing reactant and produce more than 200% more H₂.

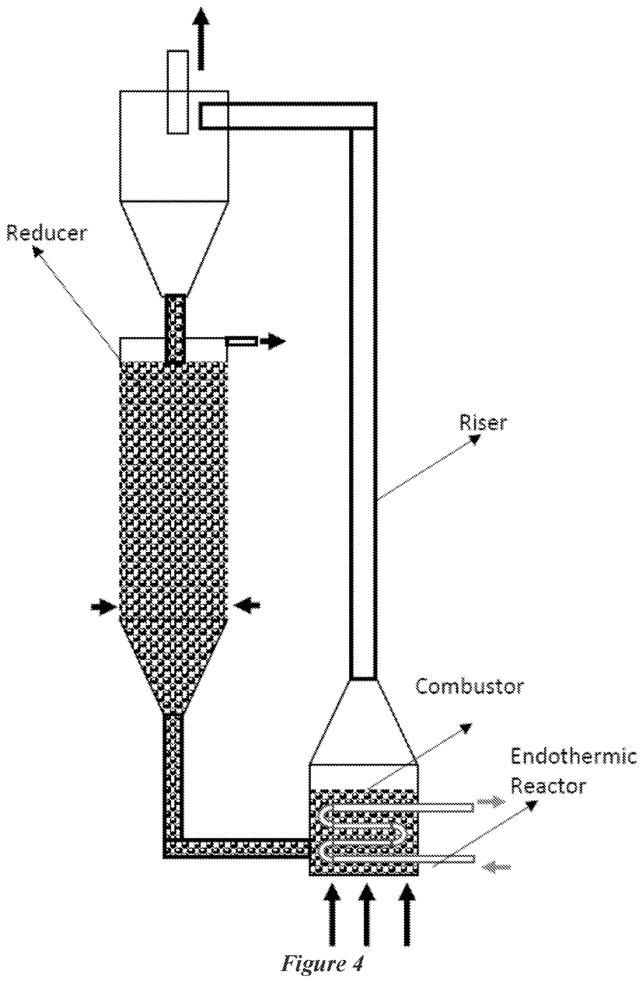

In one example, as shown in FIG. 4, the endothermic reactor can be placed horizontally inside the combustor. The reactants that flow through the endothermic reactor can undergo chemical and/or physical reactions. The shell of the endothermic reactor not only prevents the reactants inside from mixing with the reactants in the moving bed redox reactors, but also functions as a heat exchanger to transfer the heat from the plurality of redox particles into the endothermic reactor to supply the heat for the endothermic reaction. The operation condition of the endothermic reactor can have a temperature range of 300 to 1500° C. and/or a pressure range of 0 to 300 atm.

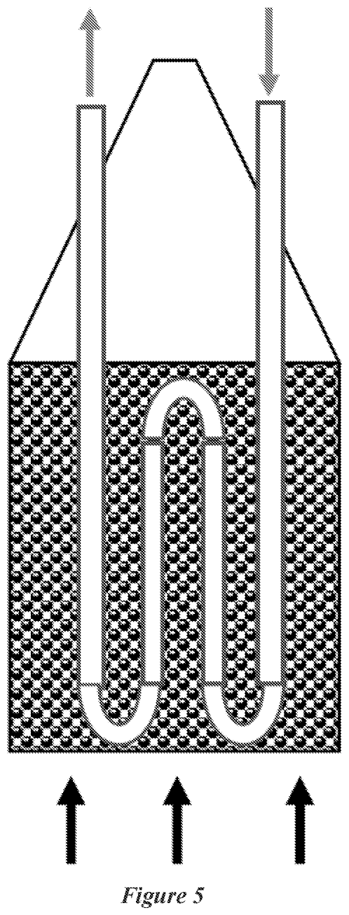

In one example, the endothermic reactor can be placed vertically inside the combustor, as shown in FIG. 5. The endothermic reactor can also be arranged as a combination of vertical and horizontal tube reactor placements, or any state-of-art arrangement, as long as the operational conditions of the endothermic reactor can be achieved, and the operation of the combustor is maintained.

In certain examples, the moving bed reducer can comprise a group of moving bed stages, fluidized bed stages, or a combination thereof connected in a manner where the gas and solids communicating between each stage behaves as a counter-current flow pattern where the plurality of redox particles communicate with the moving bed reducer stages in the opposite direction as the gas phase and the extent of reduction of the plurality of redox particles and/or composition of carbon containing reactant changes from one stage to the next.

In additional example, a particle oxidation reactor can be placed between the moving bed reducer and the combustor where an oxidizing gas can be used to oxidize the plurality of redox particles partially or fully, where the oxidizing gas comprises an oxidant that is not air. Examples oxidizing gasses include, but are not limited to, steam, CO₂, NO₂, and SO₂. The particle oxidation reactor can be operated as a countercurrent moving bed reactor, a fluidized bed reactor, or a combination thereof.

In another example, the moving bed redox system can comprise a system with the particle oxidation reactor and the moving bed reducer, without the incorporation of the combustor. In this example the endothermic reactor can be placed in the moving bed reducer or the particle oxidation reactor.

In certain examples, the plurality of redox particles can comprise of an iron-based composite metal oxide where the extent of reduction of the particles is from primarily Fe₂O₃ to FeO in the moving bed reducer and from FeO to Fe₂O₃ in the combustor (when present) and/or particle oxidizer (when present). The particle size of the plurality of redox particles can range from 0.4 mm to 10 mm in diameter.

In additional examples, a portion of the carbon containing reactant or other combustible fuels, which may not contain carbon, can be directly introduced to the combustor for direct combustion with air. Such examples will further reduce the particle circulation to heat produced ratio while potentially resulting in reduced carbon capture if the combustible fuel fed to the combustor contains carbon.

In yet another example, a solar receiver can be placed between the moving bed reducer and combustor where the plurality of redox particles serve as the heat transfer solid particles to recover the solar thermal energy. In this configuration, a higher production amount of the desired product can be achieved from the endothermic reactor per amount of carbon containing reactant processed in the moving bed reducer.

In another example, a secondary solid particle maybe incorporated to the redox system to provide additional heat capacity to the moving bed redox system. The secondary solids may also be used to remove containments in the carbon-containing reactant such as sulfur or mercury containing species.

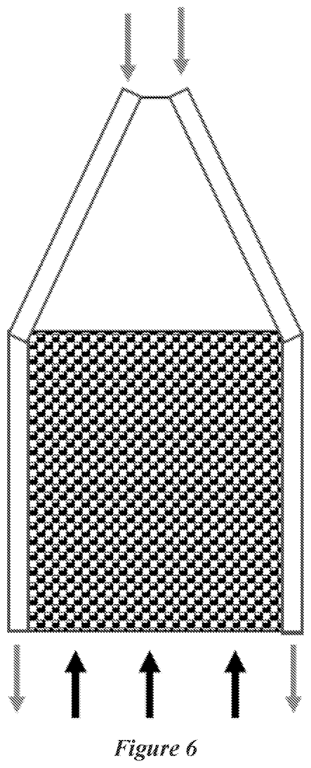

In yet another example, as shown in FIG. 6, the endothermic reactor can be designed to be the outer wall of the combustor and/or moving bed reducer. In this design, the material cost of the system can be reduced as there is no need for an additional thermal insulation in the moving bed redox reactor. The heat loss of the system can be reduced as all the heat transferred through the outer wall will be absorbed by the endothermic reactor. The operation of the moving bed redox system will not be interrupted by the placement of endothermic reactor either.

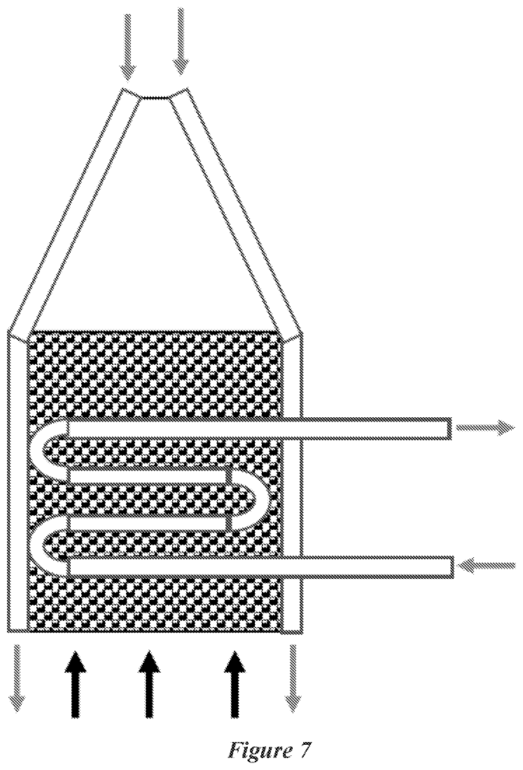

In yet another example, as shown in FIG. 7, the endothermic reactor can be placed both inside the combustor and/or the moving bed reducer and in the outer wall of the combustor and/or the moving bed reducer.

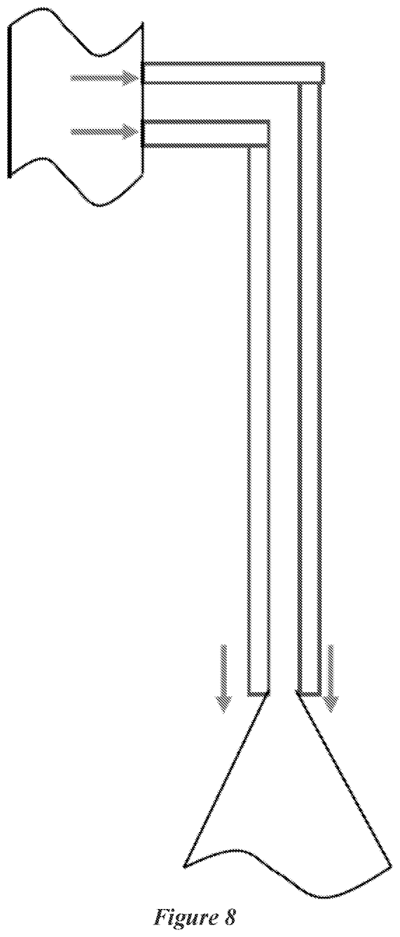

In yet another example, as shown in FIG. 8, the endothermic reactor can also be designed as the outer wall of the riser to further increase the area of heat transfer between the redox reactor system and the endothermic reactor.

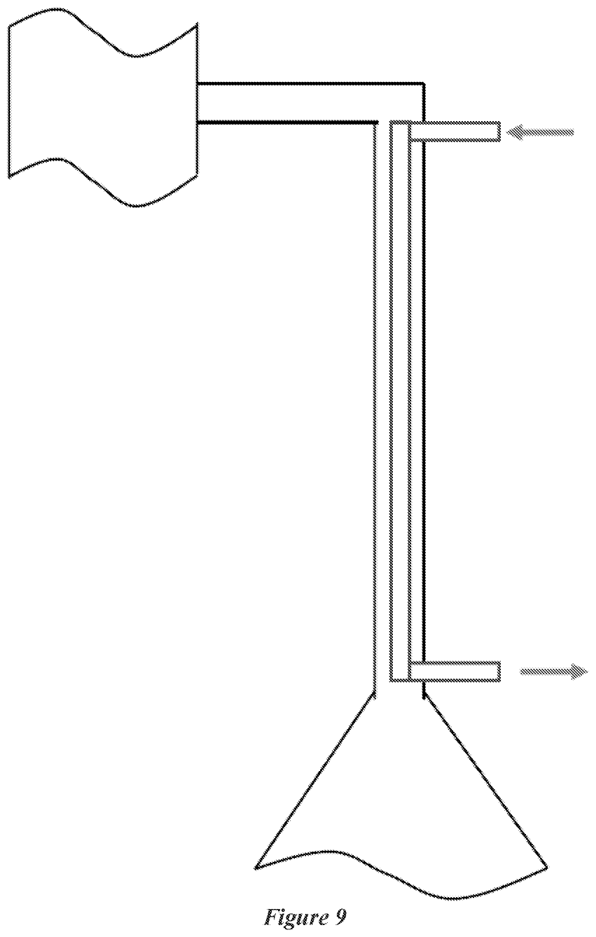

In yet another example, as shown in FIG. 9, the endothermic reactor can also be placed inside the riser to provide a greater increase in contact area between the plurality of redox particles and the endothermic reactor.

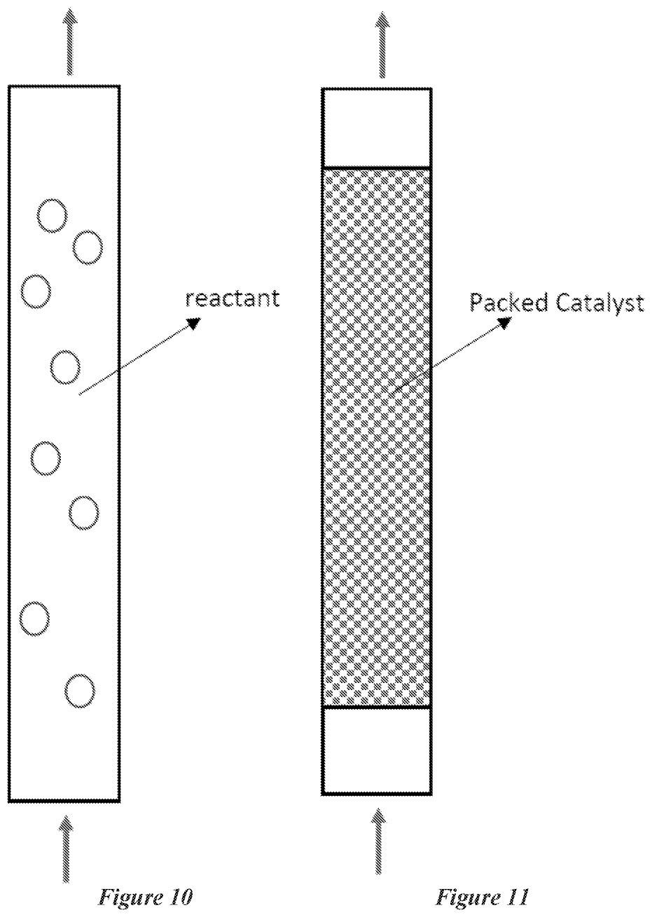

In one example, as shown in FIG. 10, the flow in the endothermic reactor can be in the form of gas, slurry, gas-solid, gas-liquid, or gas-liquid-solid. The state-of-art design of inner side of the endothermic reactor is performed based on the need of the flow of the reactants.

In another example, as shown in FIG. 11, the endothermic reactor can be a fixed bed packed by catalyst. The reactants flow through interstitial space of the catalyst and perform chemical and/or physical reactions.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The systems and methods of the appended claims are not limited in scope by the specific systems and methods described herein, which are intended as illustrations of a few aspects of the claims and any systems and methods that are functionally equivalent are intended to fall within the scope of the claims. Various modifications of the systems and methods in addition to those shown and described herein are intended to fall within the scope of the appended claims. Further, while only certain representative system components and method steps disclosed herein are specifically described, other combinations of the system components method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

1. A system for supplying thermal energy to an endothermic chemical process, the system comprising:
a first reactor comprising a moving bed reducer;
a second reactor comprising a combustor;
a plurality of redox particles comprising a metal oxide based redox material; and
an endothermic reactor;
wherein the first reactor and the second reactor are interconnected and the system is configured to cycle the plurality of redox particles between the first reactor and the second reactor;
wherein the plurality of redox particles have a first oxidation state and a second oxidation state, the second oxidation state being lower than the first oxidation state;
wherein the first reactor is configured to receive a carbon-containing reactant and at least a portion of the plurality of redox particles, said portion of the plurality of redox particles being in the first oxidation state;
wherein, within the first reactor, the plurality of redox particles flow downwards in a packed moving bed manner while the carbon-containing reactant flows upwards at a velocity below the minimum fluidizing velocity of the plurality of redox particles;
wherein the carbon-containing reactant reacts with the plurality of redox particles in the first oxidation state within the first reactor, such that the carbon-containing reactant is oxidized to form an oxidation product and the plurality of redox particles are reduced from the first oxidation state to the second oxidation state;
wherein the second reactor is configured to receive air and at least a portion of the plurality of redox particles, said portion of the plurality of redox particles being in the second oxidation state;
wherein the plurality of redox particles in the second oxidation state react with the air in the second reactor, such that the plurality of redox particles are oxidized from the second oxidation state to the first oxidation state by the air;
wherein the reaction within the first reactor, the reaction within the second reactor, one or more products of the reaction within the first reactor and/or the second reactor, or a combination thereof generates thermal energy; and
wherein the endothermic reactor is configured to receive at least a portion of said thermal energy to drive the endothermic chemical process.

2. The system of claim 1, wherein the second reactor comprises a fluidized bed, a moving bed, or a combination thereof.

3. The system of claim 1, further comprising a third reactor comprising a particle oxidation reactor between and connected to both the first reactor and the second reactor, wherein the particle oxidation reactor is configured to contact the plurality of redox particles with an oxidizing gas to at least partially oxidize the plurality of redox particles.

4. (canceled)

5. The system of claim 3, wherein the particle oxidation reactor is configured as a countercurrent moving bed reactor, a fluidized bed reactor, or a combination thereof.

6. The system of claim 3, wherein the oxidizing gas is not air.

7. The system of claim 3, wherein the oxidizing gas comprises steam, CO₂, NO₂, SO₂, or a combination thereof.

8. The system of claim 1, wherein the first reactor comprises a group of moving bed stages, fluidized bed stages, or a combination thereof.

9. (canceled)

10. (canceled)

11. The system of claim 1, wherein the carbon-containing reactant comprises natural gas, coal, biomass, or a combination thereof.

12. The system of claim 1, wherein the carbon-containing reactant is produced in another process that is upstream or downstream of the endothermic reactor.

13. The system of claim 12, wherein the carbon-containing reactant is a slip stream of the products or a tail gas from the upstream or downstream process.

14. The system of claim 1, wherein the oxidation products comprise CO₂, H₂O, or a combination thereof.

15. (canceled)

16. (canceled)

17. The system of claim 1, wherein the plurality of redox particles comprise an iron oxide.

18. The system of claim 1, wherein the plurality of redox particles in the first oxidation state comprises Fe₂O₃, wherein the plurality of redox particles in the second oxidation state comprise FeO, or a combination thereof.

19-21. (canceled)

22. The system of claim 1, wherein the endothermic reactor is a tube-type reactor.

23. The system of claim 1, wherein the endothermic reactor is embedded inside;
the first reactor;
the second reactor;
a conduit fluidly connected to and downstream of the first reactor, the second reactor, or a combination thereof;
or a combination thereof.

24. The system of claim 1, wherein the endothermic reactor is located horizontally and/or vertically inside the second reactor.

25. The system of claim 1, wherein the endothermic reactor forms an outer wall of the first reactor and/or the second reactor.

26-30. (canceled)

31. The system of claim 1, wherein the endothermic reactor comprises a fixed bed packed by a catalyst.

32. The system of claim 1, wherein the endothermic chemical process comprises steam methane reforming, methane dry reforming, methane dehydrogenation, ethane dehydrogenation, propane dehydrogenation, ethylbenzene dehydrogenation, or a combination thereof.

33-42. (canceled)

43. A method for supplying thermal energy to an endothermic chemical process, the method comprising:
contacting a carbon-containing reactant with at least a portion of a plurality of redox particles in a first reactor;
wherein the first reactor is a moving bed reducer;
wherein the plurality of redox particles comprise a metal oxide based redox material, and the plurality of redox particles have a first oxidation state and a second oxidation state;
wherein said portion of the plurality of redox particles are in the first oxidation state;
wherein, within the first reactor, the plurality of redox particles flow downwards in a packed moving bed manner while the carbon-containing reactant flows upwards at a velocity below the minimum fluidizing velocity of the plurality of redox particles;
wherein the carbon-containing reactant reacts with the plurality of redox particles in the first oxidation state within the first reactor, such that the carbon-containing reactant is oxidized to form an oxidation product and the plurality of redox particles are reduced from the first oxidation state to the second oxidation state;
transferring at least a portion of the plurality redox particles in the second oxidation state to a second reactor, the second reactor comprising a combustor;
contacting said portion of the plurality of redox particles in the second oxidation state with air in the second reactor;
wherein the plurality of redox particles in the second oxidation state react with the air in the second reactor, such that the plurality of redox particles are oxidized from the second oxidation state to the first oxidation state by the air;
wherein the reaction within the first reactor, the reaction within the second reactor, one or more products of the reaction within the first reactor and/or the second reactor, or a combination thereof generates thermal energy; and
transferring at least a portion of said thermal energy to an endothermic reactor to drive the endothermic chemical process.

44-83. (canceled)
